(19) United States
(12) Patent Application Publication
(10) Pub. No.: US 2006/0083359 A1
(43) Pub. Date: Apr. 20, 2006

(54) Apparatus for mail delivery notification and process for doing same

(76) Inventor: Alfred Kariuki Mukunya, West Chester, PA (US)

Correspondence Address: Alfred Kariuki Mukunya, 250 Weatherhill Dr., West Chester, PA, 19382, US

(21) Appl. No.: 11/208,212

(22) Filed: Aug. 20, 2005

Related U.S. Application Data
(60) Provisional application No. 60/619,408, filed on Oct. 16, 2004.

(51) Int. Cl. H04M 11/00; H04M 1/64

(52) U.S. Cl. 379/88.13; 379/88.17

(57) ABSTRACT

An Apparatus for Mail Delivery Notification and Process for doing same. This consists of an imaging device at point of entry for physical mail, a sensing mechanism responsive to entry of mail at the delivery point, thereby triggering the imaging of the physical mail, a connection to an electronic storage device to store images taken from image device, and a connection to an email device to send images electronically over the internet.

### CROSS REFERENCE TO RELATED APPLICATIONS

This application claims the benefit of U.S. Patent Provisional Application No. 60/619,408 filed on Oct. 16, 2004 and is incorporated herein by reference.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of mail and document delivery and more specifically to an Apparatus for Mail Delivery Notification and Process for doing same.

The field of communication is one of the fastest growing sectors of the economy. Communication enables business, economic and personal transactions and fuels the global economy. The two basic modes of communication are electronic and hardcopy communications. Examples of electronic communication are electronic mail (e-mail), while an example of hardcopy communication is traditional mail delivery. A vast majority of the population uses traditional hardcopy mail. It is delivered to a mail box in a post office, apartment building or outside the home. There are advantages and disadvantages to each mode of communication. Hardcopy communication is slower and more expensive. One disadvantage of hardcopy mail is that the only practical way for a user to know for certain whether their mail has been delivered is to travel to the location of the mail box and retrieve the mail. The travel to and from a mailbox whether or not there is mail delivered adds to the cost of traditional mail.

The cost, time and inconvenience of travel to retrieve physical mail is also increased during unfavorable weather or when the mail recipient finds it difficult to travel due to advanced age or illness.

More than 20% of the population in the USA and industrial world in general have access to electronic mail via Internet. This number is expected to continue to grow dramatically in the future. However, there is no indication that this form of mail will replace the physical delivery of mail. The present invention provides an effective communication system that links the domain of physical delivery of mail with the domain of electronic communications to optimize communications of both methods of information delivery, thus harnessing the advantages of each domain, in a manner currently unavailable today.

Earlier technology has focused on notifying the recipient of delivered mail. U.S. Pat. No. 6,463,354 defines a system and method for automatic notification of upcoming delivery of mail item. When a mailer generates a mail piece, the mailer has an option to notify a recipient that mail has been sent. A Digital Post Mark unique to the mail piece is sent, and maybe an estimated date of delivery. This invention is limited to one way communication in terms of notifying delivery of the information.

Other technological improvements are limited to each domain, for example just in the electronic domain or the physical domain with regard to mail. Prior technology does not address the notification of mail being present in a mailbox using digital electronic means.

This invention reduces the costs associated with physical mail, where the retrieval from the mailbox is done only when the user decides they need to travel to the mailbox as they would know for certain mail has been delivered. The process also allows for visualizing an image of the physical mail that has been delivered. This invention also provides for monitoring the contents of the mailbox.

### BRIEF SUMMARY OF THE INVENTION

The primary object of the invention is to provide an apparatus and method for the notification of arrival of physical mail.

Another object of the invention is to provide an apparatus and method that allows mail box users to know when and whether mail has been delivered.

Another object of the invention is to provide an apparatus and method that links physical mail to elecronic mail.

A further object of the invention is to provide an apparatus and method that improves the efficiency of physical mail users, so a user knows availability of mail before going to retrieve it.

Yet another object of the invention is to provide an apparatus and method that enables for scanning or taking an electronic image of physical mail for electronic delivery.

Still yet another object of the invention is to provide an apparatus and method of enabling user to monitor, view and know the contents of a mailbox.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an Apparatus for Mail Delivery Notification and Process for doing same. comprising: An imaging device at mail receptacle, a sensing mechanism responsive to entry of mail at the receptacle, thereby triggering the image capture of the physical mail, a processor and memory that processes and sends the image through an internet or wirelss connection using email, or other electronic or wireless method.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a networked physical mail system in accordance with a preferred embodiment of the present invention.

FIG. 2 depicts a flowchart of the process in an embodiment of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In the present invention, there is provided a flexible apparatus for ensuring a physical mail box user is notified of the receipt of mail, and process for doing same, without the user having to be physically present at the point of physical document delivery. The point of physical document delivery could be the mail box or at the post office. In one embodiment, a mail receptacle or a device in the mail receptacle is programmed to automatically capture, store and send images of received mail. The method of sending the message of incoming mail could be programmed to be either a simple text message alert, or a front and back view of the image of the mail document received. The message could be sent to a telephone, cell phone, or email address. This and other embodiments are described in further detail below.

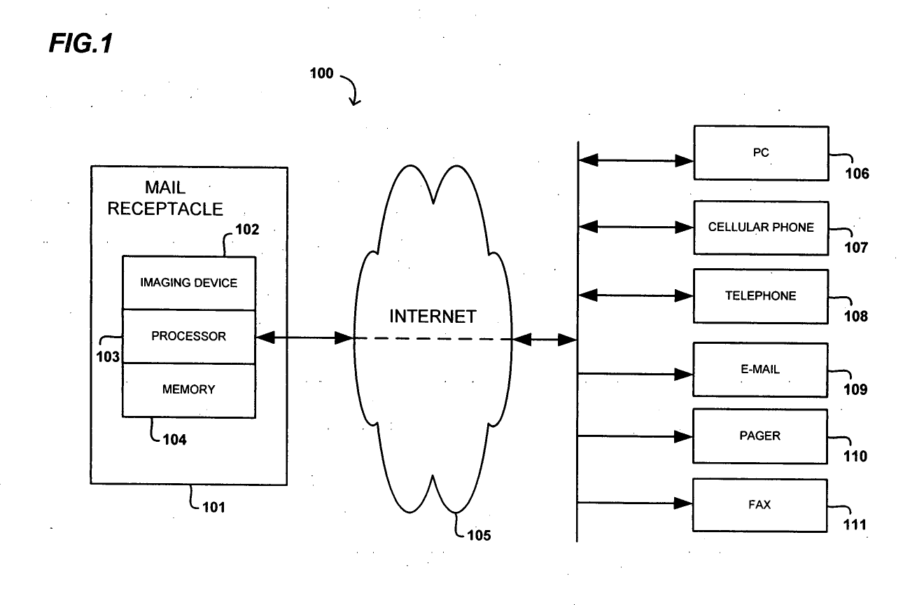

Referring now to FIG. 1, there is shown a networked physical mail system 100 in accordance with a preferred embodiment of the present invention. Mail system 100 comprises the mail receptacle 101, the imaging device 102, processor 103 and electronic storage device 104, and various notification means such as a PC 106, Cellular Phone 107, Telephone 108, E-Mail address 109, Pager 110 or Fax 111. In an embodiment of this invention, the imaging and processing device is connected to the Internet 111. This enables the device to send and receive electronic information regarding documents received or contained in the receptacle through the Internet. It allows for flexible access to the digital storage information contained in the image and processing device. The imaging and processing device can have a sensing mechanism responsive to incoming mail, thereby triggering image scanning or capture as the mail is being dropped. It can also be programmed to only send images contained. An alternative embodiment is for the imaging and processing device to be used as a constant monitoring device for the mail receptacle, allowing for viewing contents of the mailbox at user's will.

Another embodiment of this invention would be for the imaging and processing device to be connected to a PC server, and then the server connects to the internet. In this manner, the programming and security of the imaging and processing devices contained in the mail receptacle could occur from a centralized point.

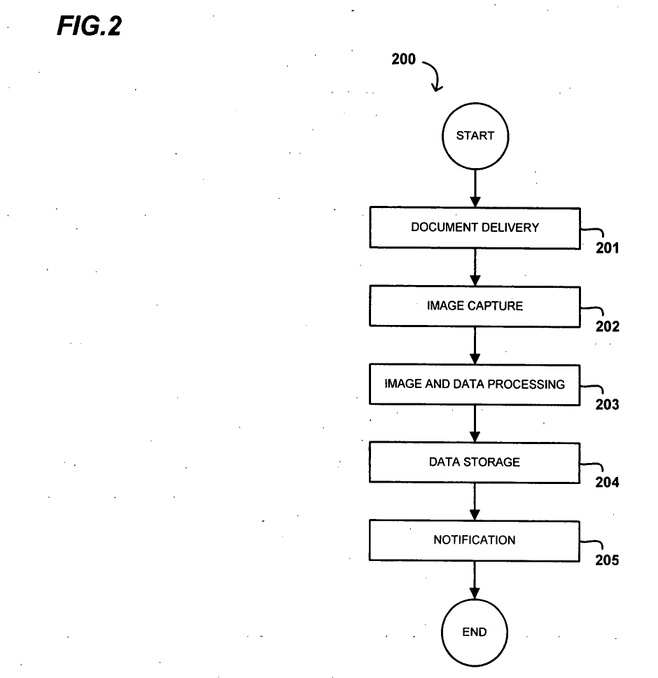

Referring now to FIG. 2, there is shown a flow diagram illustrating the phases of implementing an embodiment of this invention. The physical mail documents are delivered at or through a receptacle in the Document Delivery stage 201. The image of the document is captured in stage 202 using a device such as a miniature camera or scanner that is triggered upon document entry. Image Processing 203 is where the captured image is processed for storage or sending. The processor could be programmed to take the image, compress it, key, tag or other perform other like processes for later storing, viewing or sending. Data Storage 204 could be performed with either temporary or permanent memory. The data is stored for access, further processing or electronic delivery. Notification 205 occurs when the data or image is sent electronically via the internet or other method to the mail box user, signaling arrival of physical mail.

This invention presents a clear advantage over what is currently available by flexibly, and at low cost connecting the two realms of physical mail and electronic mail. Other inventions provide solutions within each realm, without necessarily linking the two. The convenience and efficiency of only visiting the mailbox when there is mail, and knowing what has been delivered before the trip to the mail box will be an immediate benefit for users of the system. In addition to saving time for all mailbox users with access to the internet, this will especially be beneficial for the elderly, invalids, or for use during inclement weather.

This paper presents the implementation and embodiments of the present invention with the help of examples. It is obvious to a person skilled in the art that this invention is not restricted to the embodiments presented above, and that the invention can be implemented in another form while maintaining the characteristics of the invention.

The embodiments presented should be considered illustrative, but not resting. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An Apparatus for Mail Delivery Notification comprising:
An imaging device at mail receptacle;
A sensing mechanism responsive to entry of mail at receptacle triggering the imaging of the physical mail;
A processor and memory to process, send or store images taken from image device; and
An internet or wireless connection from mail receptacle enabling image or data to be sent electronically to another device.

2. A Process for Mail Delivery Notification. comprising the steps of:
Image capture at mail receptacle;
A sensing mechanism responsive to entry of mail at the delivery point, thereby triggering the imaging of the physical mail;
Processing, sending or storing images taken from imaging device; and
Sending data or images wirelessly or through a connection to another electronic device.
